(19) United States
(12) Patent Application Publication
(10) Pub. No.: US 2017/0317837 A1
(43) Pub. Date: Nov. 2, 2017

(54) SYSTEMS AND METHODOLOGIES FOR CERTIFICATE VALIDATION

(71) Applicants: ARWA ALRAWAIS, WASHINGTON, DC (US); ABDULRAHMAN ALHOTHAILY, WASHINGTON, DC (US)

(72) Inventors: ARWA ALRAWAIS, WASHINGTON, DC (US); ABDULRAHMAN ALHOTHAILY, WASHINGTON, DC (US)

(21) Appl. No.: 15/243,619

(22) Filed: Aug. 22, 2016

Related U.S. Application Data
(60) Provisional application No. 62/329,684, filed on Apr. 29, 2016.

(51) Int. Cl. H04L 9/32; H04L 9/30; H04L 9/00; H04L 9/14

(52) U.S. Cl. CPC H04L 9/3268; H04L 9/3249; H04L 9/3239; H04L 9/006; H04L 9/14; H04L 9/302

(57) ABSTRACT

A system and method for certificate validation. The method includes acquiring revocation information associated with one or more revoked certificates from a plurality of certificate authorities, signing the revocation information, and storing the signed revocation information. Further, the method includes receiving a request from a client to connect to a web server. In response to the request, certificate information from the web server is received. The method further includes comparing the certificate information with stored revocation information and terminating a connection between the web server and the client when the certificate information matches a revoked certificate information included in the stored revocation information.

### CROSS-REFERENCE TO RELATED APPLICATIONS

This application claims the benefit of priority from U.S. Provisional Application No. 62/329,684 filed Apr. 29, 2016, the entire contents of which are incorporated herein by reference.

### BACKGROUND

Web services provide information, products, and services to users. A major concern for the users and the web services is the security of the Internet. Public Key Infrastructure (PKI) enables users of an unsecured public network, such as the Internet, to securely exchange data and communication over the network. PKI provides secure communications between two entities over an insecure channel and verifies the entities' identities via a digital signature. A component of PKI is a digital certificate (certificate). The certificate is basically a bit of information that says that a particular computer or web server is trusted by an independent source known as a certificate authority. Certificate validation in PKI is a vital phase of establishing secure communications on any network.

The foregoing “Background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention.

### SUMMARY

The present disclosure relates to a method that includes acquiring revocation information associated with one or more revoked certificates from a plurality of certificate authorities, signing the revocation information, sending the revocation information to at least one proxy server, and storing the signed revocation information in a memory of a proxy server. Further, the method includes receiving a request from a client to connect to a web server. In response to the request, certificate information from the web server is received. The method also includes comparing, via processing circuitry, the certificate information with stored revocation information. Further, the processing circuitry terminates a connection between the web server and the client when the certificate information matches a revoked certificate information included in the stored revocation information.

The foregoing paragraph has been provided by way of general introduction, and is not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram that shows an internet service provider (ISP) architecture according to one example;

FIG. 2 is a schematic that shows the number of digital certificates issued by a certificate authority (CA) according to one example;

FIG. 3 is a schematic that shows the number of certificates as a function of the key size according to one example;

FIG. 4 is a schematic diagram of a system for certificate validation according to one example;

FIG. 5 is a flowchart that shows a method for certificate validation according to one example;

FIG. 6 is a flowchart that shows a process for establishing a connection between a client and a web server according to one example;

FIG. 7 is a flowchart that shows a process for establishing a connection between the client and the web server according to one example;

FIG. 8 is a schematic that shows a plurality of performance parameters of the system according to one example;

FIG. 9 is an exemplary block diagram of a server according to one example;

FIG. 10 is an exemplary block diagram of a data processing system according to one example; and

FIG. 11 is an exemplary block diagram of a central processing unit according to one example.

### DETAILED DESCRIPTION

Referring now to the drawings, wherein like reference numerals designate identical or corresponding parts throughout several views, the following description relates to a system and associated methodology for certificate validation and revocation.

Public Key Infrastructure (PKI), which is built on public key cryptography, aims to provide secure communications between two entities without existing relationship over an insecure channel and verifies the entities' identities via digital signatures. Fundamentally, the underlying security of many protocols such as transport layer security (TLS) and secure sockets layer (SSL) is based on the successful implementation of a PKI. The PKI includes many components, including a Certificate Authority (CA). The CA is a trusted authority that issues digital certificates. The CA publishes and digitally signs a certificate that binds a public key to its associated identity. Besides issuing a certificate, the CA is also responsible for revoking certificates. A revoked certificate is one that is invalid and may not be used by any application or system. There are many reasons for CAs to revoke a previously issued certificate. One of the most significant reasons is that a certificate might be compromised, which occurs when an attacker learns the original owner's private key, allowing impersonation of the owner's certificate. Once a certificate is compromised, the owner (e.g., CA) revokes the certificate as quickly as possible to prevent security risks that can affect clients who accept the compromised certificate as described in L. Zhang, D. Choffnes, D. Levin, T. Dumitras, A. Mislove, A. Schulman, and C. Wilson, “Analysis of SSL certificate reissues and revocations in the wake of heartbleed,” in Proceedings of the 2014 Conference on Internet Measurement Conference, ACM, 2014, pp. 489-502 incorporated herein by reference in its entirety. Therefore, there is a need for an efficient and secure certificate validation system.

One validation method for disseminating certificate revocation information is to publish Certificate Revocation Lists (CRLs). A CRL is a blacklist of certificates that cannot be trusted. The CAs publish and maintain CRLs at regular time intervals. CRLs contain many invalid certificates that were digitally signed by their CAs to prevent attackers from manipulating or substituting certificates with fraudulent ones as described in R. L. Rivest, “Can we eliminate certificate revocation lists?” in Financial Cryptography, Springer, 1998, pp. 178-183. However, clients download updated CRLs infrequently, which make their copies vulnerable and outdated. Additionally, the length of a CRL may eventually increase to a cumbersome size; thus downloading CRLs in a low-speed network may result in an excessive network bandwidth usage, causing long delay and congestion. A validation system has the following properties:

Response time: Once a certificate is revoked, all involved entities should learn about the revocation as soon as possible, for example, in the order of milliseconds. Current systems take hours and days for example.

Network overhead: Clients should not experience a validation delay, and the burden on network infrastructure should be reduced. Thus, the bandwidth consumption scales well not only with the number of clients, but also with the number of CAs and that of the revoked certificates.

Security: Once a certificate is revoked, the validation system should be updated immediately with this revocation information to protect clients from accepting a revoked certificate. Moreover, the validation system should employ some cryptographic methods to prevent against common attacks in validation systems.

Applicability: A certificate validation system can be applicable to any device, including mobile devices that perform a validation process with less computational cost.

Current certificate validation systems face trade-offs among the properties described above. Meeting all the desired properties has proven to be difficult and current certificate validation systems fail to achieve one or more of the major properties mentioned above. In fact, CRLs fail to update clients instantly with the latest revocation information, leaving them vulnerable to many attacks for multiple days. An early study showed that after two days of issuing new certificates, 30% of them had been revoked as described in C. Ma, N. Hu, and Y. Li, “On the release of CRLs in public key infrastructure,” in USENIX Security, 2006, incorporated herein by reference in its entirety.

The Online Certificate Status Protocol (OCSP), an alternative to CRL, allows clients to request current certificate status information from CAs. OCSP adds an extra delay at the client side because a round trip time is performed when obtaining the certificate validation information. OCSP Stapling (Online Certificate Status Protocol Stapling) is a modification of OCSP, which aims to mitigate the shortcomings of OCSP. Nevertheless, it has not been widely adopted. The analysis described herein shows that only 10% of the servers in an exemplary dataset support OCSP Stapling, partially because the system is vulnerable to a “soft fail” situation which occurs when an attacker blocks the access to an OCSP server, causing the browsers to permit malicious connections.

Certificate Revocation List (CRL) is the most common certificate validation method. As mentioned previously herein, CRL suffers from several limitations, among which time delay is the most significant one—it takes hours or even days to update clients. Moreover, the size of a CRL file consumes a high bandwidth to distribute the entire revocation list to multiple clients. Besides that, clients with limited computing resources such as smartphones and smart meters are not able to download large CRL files to verify the digital certificates.

OCSP is used to check the status of an identified certificate, after the client submits an OCSP request to an OCSP responder. The OCSP responder is responsible for processing any OCSP request by sending the request to the CA to check the certificate status. Then, the OCSP responder signs and sends the CA response that contains the certificate status to the client as described in M. Myers, R. Ankney, A. Malpani, S. Galperin, and C. Adams, “X.509 internet public key infrastructure online certificate status protocol-ocsp,” RFC 2560, Tech. Rep., 1999, incorporated herein by reference in its entirety.

CAs update all OCSP responders that reply to the clients with less information than a CRL. Thus, OCSP uses fewer network resources than the CRL system. However, the increasing number of OCSP responses introduces a cost to the CAs when responding to millions of clients in real-time. On the other hand, OCSP is able to complete a validation process in a short period of time. Nevertheless, it presents a delay in terms of a client's latency: the client needs to communicate with a third party to validate the digital certificate, which could slow down the establishment of a secure communication session. Additionally, the growth in the number of clients also puts a tremendous burden on the OCSP server. Finally, if a client is not able to receive an OCSP response due to OCSP server attacks, the client chooses either to continue at the risk of insecurity, or terminate its communication.

Online Certificate Status Protocol Stapling is a modification of OCSP, where the certificate status is attached, or “stapled”, to the requested certificate. OCSP Stapling could not address all the problems in OCSP. It reduces the latency involved in OCSP because a client may not communicate with the OCSP server; instead, the server (i.e., the certificate holder) communicates with the issuer CA at regular intervals. However, OCSP Stapling is not widely supported. The main reason to have OCSP Stapling disabled in the majority of the servers is that the system is vulnerable to a kind of “soft fail”, a situation that causes the browsers to permit malicious connections.

Short-Lived Certificate (SLC) is a regular X.509 certificate that is issued for a short period of time. The period is an average of OCSP cashing, which is four days as described in E. Topalovic, B. Saeta, L.-S. Huang, C. Jackson, and D. Boneh, “Towards short-lived certificates,” Web 2.0 Security and Privacy, 2012, incorporated herein by reference in its entirety. When a certificate approaches its expiration date, the CA issues a new one as described in B. Morton, “Short-lived certificates,” Secure Browsing, SSL, Technical, 2012 incorporated herein by reference in its entirety. The burden of certificate validation is excluded from secure communications, and is processed offline. However, the number of issued certificates is increased significantly. Thus, more resources are spent on the server side to fetch and send certificates more frequently. Additionally, SLC requires a significant amount of network resources from CAs, which are increased with the growing number of issued certificates.

RevCast is a recently proposed certificate validation approach described in A. Schulman, D. Levin, and N. Spring, “Revcast: Fast, private certificate revocation over FM radio,” in Proceedings of the 2014 ACM SIGSAC Conference on Computer and Communications Security, ACM, 2014, pp. 799-810 incorporated herein by reference in its entirety. RevCast is a broadcast system that distributes revocation information for multiple clients. Once a certificate is revoked, each CA broadcasts the certificate revocation information over a radio station to the clients. This approach requires an extra hardware receiver integrated with the client's device to receive revocation information. A client PC has a hardware receiver, and client smartphones integrate an FM (Frequency modulation) antenna in order to receive the distributed revocation information. Additionally, in the event that a transmission is lost, clients are required to download CRL files over the Internet. RevCast is limited to metropolitan areas where the FM tower coverage is available.

Some approaches to designing a certificate validation system in a PKI environment follow a design that aims to reduce the latency in secure communications. For example, a certificate prefetching and pre-validation mechanism was described in E. Stark, L.-S. Huang, D. Israni, C. Jackson, and D. Boneh, “The case for prefetching and prevalidating TLS server certificates,” in Network and Distributed system security (NDSS) symposium, 2012, incorporated herein by reference in its entirety, to pre-validate a server's certificate and remove the time pressure from the SSL/TLS handshake. This approach utilizes a preliminary processing time to fetch and validate the certificate.

Other implementations focus on eliminating a CA's role in distributing the revoked certificates in a PKI. The DNS (Domain Name System)-based Authentication of Named Entities (DANE) described in P. Hoffman and J. Schlyter, “The DNS-based authentication of named entities (DANE) transport layer security (TLS) protocol: Tlsa,” Tech. Rep., 2012, incorporated herein by reference in its entirety, involves a domain operator to take on the role of a CA, and signs a certificate within its domain. A DNS record distributes and caches the certificate on its server to lower the round trip time of communications. The Google certificate catalog as described in B. Laurie, “Improving SSL certificate security,” 2011, is another scheme that excludes the role of a CA in the certificate validation process. It crawls all the valid SSL certificates' websites and stores them in a database published in the DNS.

There also exist approaches that attempt to use publicly verifiable logs to reduce the scope of a CA's role in a PKI. The authors in M. D. Ryan, “Enhanced certificate transparency and end-to-end encrypted mail,” Proceedings of NDSS, The Internet Society, 2014, incorporated herein in reference by its entirety, extended a certificate's transparency to handle the certificate revocation information. An end-to-end secure email and messaging protocol in a PKI environment with no need to trust a third party such as a CA is described. A drawback of the described protocol is that when each time a client loses its identity, the client needs to create a new one as described in D. Basin, C. Cremers, T. H.-J. Kim, A. Perrig, R. Sasse, and P Szalachowski, “Arpki: Attack resilient public-key infrastructure,” in Proceedings of the 2014 ACM SIGSAC Conference on Computer and Communications Security, ACM, 2014, pp. 382-393 incorporated herein by reference in its entirety.

A trusted party, known as a notary, has also been employed for certificate validation. Convergence allows notaries at the client side to validate communications with websites. This approach reduces the risk when a CA is compromised, but the network overhead is significantly increased as described in M. Marlinspike, “Convergence (2011)”. A group of notary hosts may also be used to watch a server's public key, and preserve a record of the server's key as described in D. Wendlandt, D. G. Andersen, and A. Perrig, “Perspectives; Improving ssh-style host authentication with multi-path probing.” in USENIX Annual Technical Conference, 2008, pp. 321-334, incorporated herein by reference in its entirety. Clients can detect attacks through comparing records against an unauthenticated key. As the system efficiency of notary based approaches relies on the notary servers, the servers' resources such as bandwidth should be powerful.

The method described herein utilizes Internet Service Providers (ISPs) that provide individuals and businesses access to the Internet. There are at least three types of ISPs: a) National ISPs are connected to each other and provide services to regional ISPs, b) Regional ISPs are connected to national ISPs, and provide services to local ISPs, and c) Local ISPs are connected to regional or national ISPs, and provide direct services to end clients as described in N. F. Mir, Computer and communication networks, Pearson Education, 2014, incorporated herein by reference in its entirety. The local ISPs redirect clients' access requests out to the Internet world. The clients' access requests pass through a proxy-cache server residing on the ISP side that provides a caching service. In addition to offering access to the Internet, ISPs provide valuable security services such as spam-blocking as described in R. Singer Gordon, “Beginning ubuntu linux: From novice to professional.”, 2006 and A. J. Broder, “Data mining the internet and privacy,” in Web Usage Analysis and User Profiling, Springer, 2000, pp. 56-73, each incorporated herein by its entirety.

The system described herein employs local ISPs to provide a certificate validation service for secure communications because an ISP proxy-cache server works as a guard for clients' Internet access requests. Such a design shifts the complexity of dealing with certificate validation from the client side to the ISP proxy-cache server side. Ordinary clients do not have to deal with the complicated countermeasures such as installing software or adding extra hardware to validate certificates. Therefore, an ISP can play a pivotal role in providing effective certificate validation service.

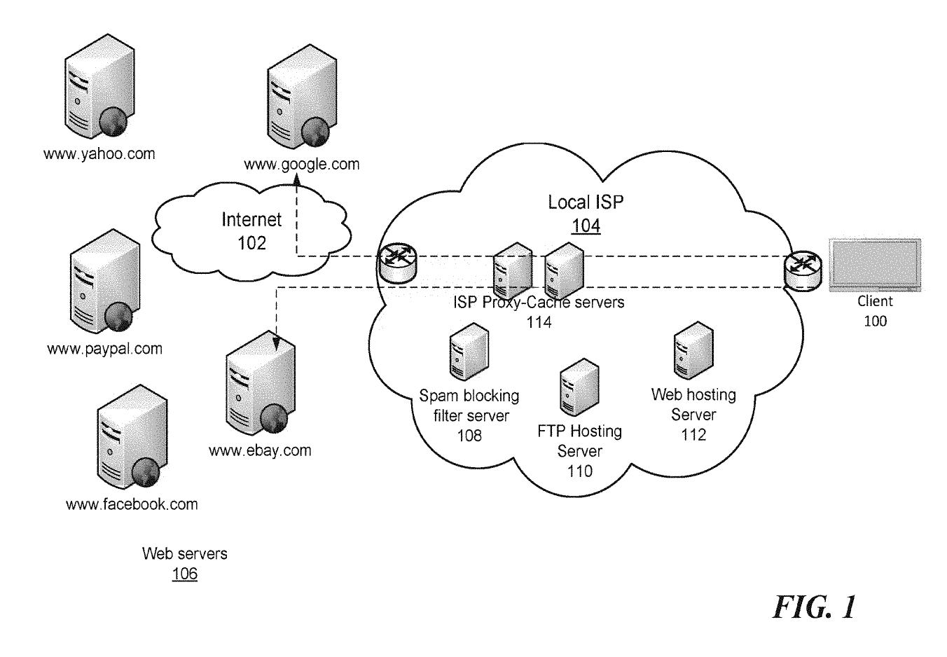

FIG. 1 is a schematic diagram that shows an internet service provider (ISP) architecture according to one example. A client 100 may be coupled to a data communication network 102, for example, the Internet (or the World Wide Web) via a local ISP 104. The local ISP 104 may include a spam blocking filter server 108, a FTP hosting server 110, a web hosting server 112, and one or more ISP proxy-cache servers 114. The client 100, the spam blocking filter server 108, the FTP hosting server 110, the web hosting server 112, and the one or more ISP proxy-cache servers 114 may communicate using a protocol such as the Hypertext Transfer Protocol (HTTP), a protocol commonly used on the Internet to exchange information. The client 100 may communicate with web servers 106 via the data communication network 102. The client 100 can resort to the one or more ISP proxy-cache servers 114 to validate certificates on the behalf of the client 100 in the local ISP 104. The client 100 may include a personal computer (PC), a smartphone, a dummy device, or the like.

The method and system described herein, “SecureGuard,” is based on the analysis of TLS handshakes of the Alexa Top 1 Million domain dataset. The certificate validation process takes place during the TLS handshake, where CRL, OCSP, or OCSP Stapling is used to validate the digital certificates in the collected dataset.

The TLS handshakes were analyzed for the Alexa Top 1 Million domain on port 443 that was scanned and collected using the ZGrab tool as described in D. H. Z. scan of the Alexa Top 1 Million domains, “The internet-wide scan data repository,” 2015. The dataset contains the full TLS handshake information, including the digital certificate for each scanned domain. The dataset was collected in February 2015 The analysis explored more than 236,000 unique digital certificates that were issued by more than 21,000 certificate authorities. It is surprising to see that 40% of the observed certificates are invalid, whereas the valid ones represent only about 60%. The reasons that a surveyed certificate may be invalid are multifold, including the use of unknown CA signatures, utilizing a weak key size, or the like.

Each certificate may include version, serial number, signature algorithm, issuer, valid from, valid to, subject, public key basic constraints, certificate policies, certificate type, CRL distribution point, thumb print algorithm, and thumb print.

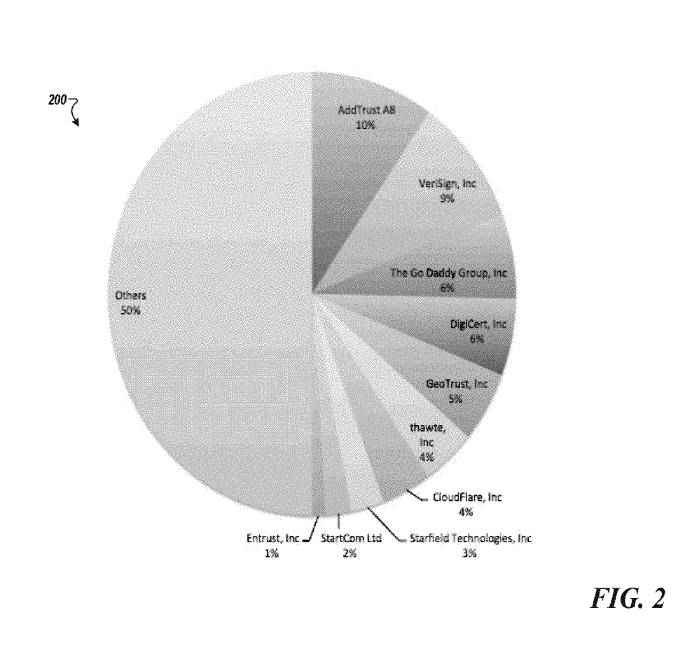

FIG. 2 is a schematic showing the number of digital certificates issued by a CA according to one example. The number of digital certificates a CA has issued varies significantly as shown in graph 200. In some examples, the top 10 CAs control 50% of the total issued digital certificates.

AddTrust AB is the most commonly used CA and it issued more than 27,000 digital certificates. 2% of the surveyed certificates have “none” listed as the organization or organizational unit. For example:

“common name”: “localhost”
“country”: “US”
“locality”: “Sometown”
“organization”: “none”
“organizational unit”: “none”
“province”: “Someprovince”

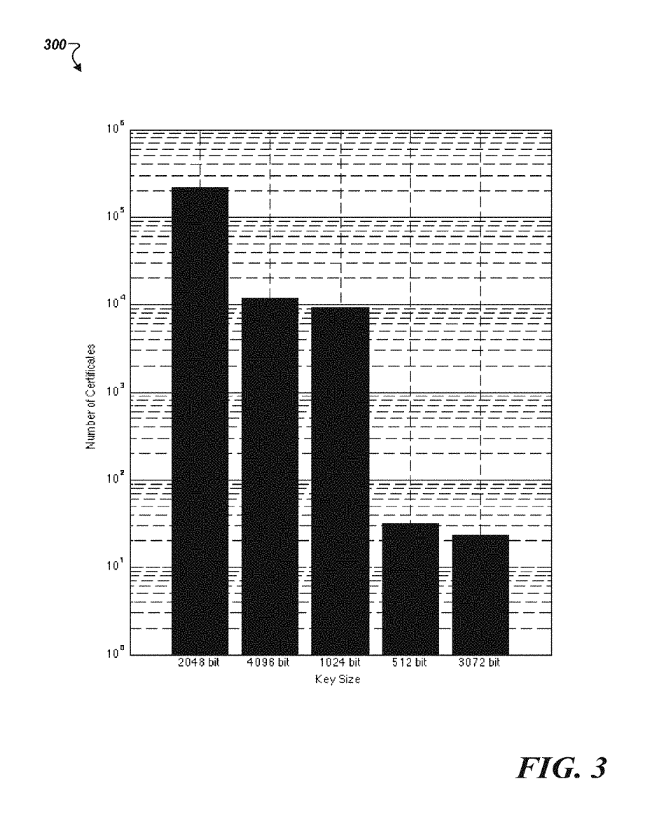

The certificates may be signed by unknown certificate authorities, which can subject clients to myriad attacks, including impersonation attacks. The key size of the algorithm that was used to sign the digital certificates was also investigated. All of the inspected certificates were signed using the RSA algorithm. A key size of 2048-bit was used to sign about 91% of the available digital certificates, and the rest were mainly signed by 1024-bit or 4096-bit keys, as shown in FIG. 3.

FIG. 3 is a schematic that shows the number of certificates as function of the key size according to one example. As shown in Graph 300, more than 30 digital certificates were signed using a poor key size of 512-bit. In 2009, Benjamin Moody factored a key size of 512-bit in 73 days using simple hardware and software on a desktop computer with less than 5 gigabytes of storage and 2.5 gigabytes of RAM as described in P. Q. Nguyen, “Public-key cryptanalysis,” Recent Trends in Cryptography, Contemporary Mathematics, vol. 477, pp. 67-120, 2009 incorporated herein by reference in its entirety. In 2011, more than five certificates with a key size of 512-bit were used to sign the malware by the same attacker as described in M. Sandee, “Rsa-512 certificates abused in the wild,” Nov. 21, 2011. This reveals that a key size of 512-bit has been shown to be easily broken and has been undermined by many attackers.

The digital certificate validity date, which is a significant indication of the certificate legitimacy, is also analyzed. Many certificates had already expired or were miss-issued. One example of a miss-issued certificate is shown below, where the validity date was issued backward:

not valid before May 4, 2014 at 10:09:19 PM Eastern Daylight Time and not valid after Nov. 18, 1902 at 2:41:03 PM GMT-05:00.

Notably, the validity period for which a certificate is valid in the previous example is about −112 years, which caused this certificate to be expired due to miss-issued dates as described in C. M. MSFT, “Operating a windows pki: Certification authority certificate lifecycle and renewals,” May 27, 2013.

The CRL files were crawled for the top 10 CAs in the dataset. The size of the CRL files varies between 793 bytes and 5 MB. The storage space and transmission cost are growing significantly with the increasing number of revoked certificates. Consequently, it requires more storage space and bandwidth to obtain the CRL files. On the other hand, it is important that the updating period between two publishes of a CRL file is very short in order to prevent clients from accepting a revoked certificate. As shown in Table I, the period length is different from one CA to another, to the extent that some updates are published after several days, weeks or even a year. Once a certificate is revoked, a client should be updated immediately; otherwise, a revoked certificate might be accepted as a valid one. Finally, 90% of the servers were disabled the OCSP Stapling by setting “OCSP Stapling: False”, while only 10% enabled the OCSP Stapling by setting “OCSP_Stapling: True”. This is because a client is vulnerable to accept a revoked certificate, when an attacker blocks the OCSP server connection.

TABLE 1
The CRL File Sizes and Update Periods
for the Top 10 Certificate Authorities

| Certificate Authority | CRL size | Update Period |
|---|---|---|
| AddTrust AB | 524 KB | Four days |
| VeriSign | 871 KB | Ten days |
| GoDaddy | 38 KB | Five days |
| DigiCert | 24 KB | Seven days |
| GeoTrust | 46 KB | Ten days |
| Thawte | 237 KB | Ten days |
| Global Sign | 5 MB | Seven days |
| Starfieid Technologies | 771 KB | Five days |
| StartCom | 793 Bytes | A year |
| Entrust | 387 KB | Seven days |

Current certificate validation systems inherently suffer from several limitations. They do not simultaneously satisfy the timeliness and accuracy of certificate validation for clients while preserving the properties of security and low operational cost. The system described herein takes into account the limitations and carefully subscribes only to trusted and known CAs that utilize a strong key size to sign their certificates. The system described herein has no inbound traffic or storage overhead at the client side; therefore, the system preserves the client's resources in terms of bandwidth, storage, and computational processing.

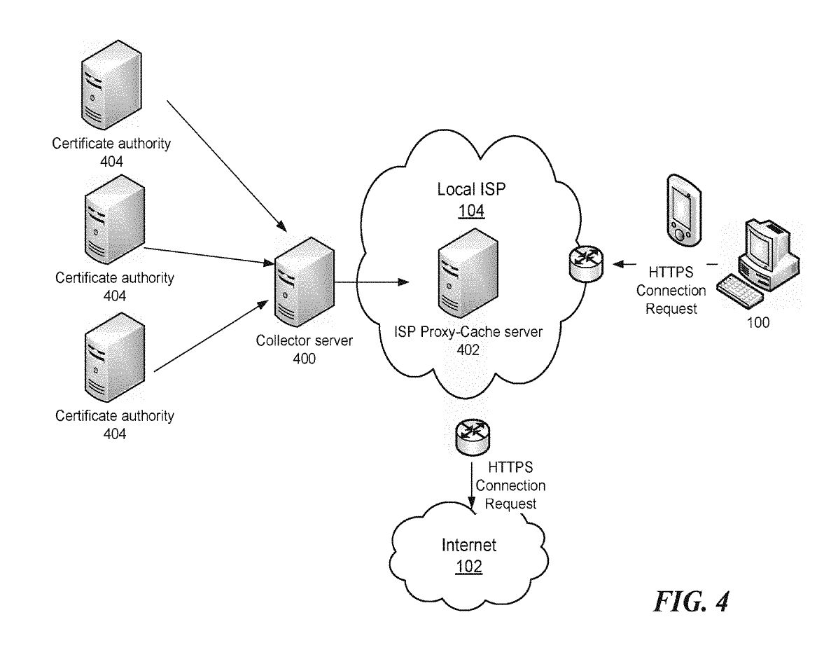

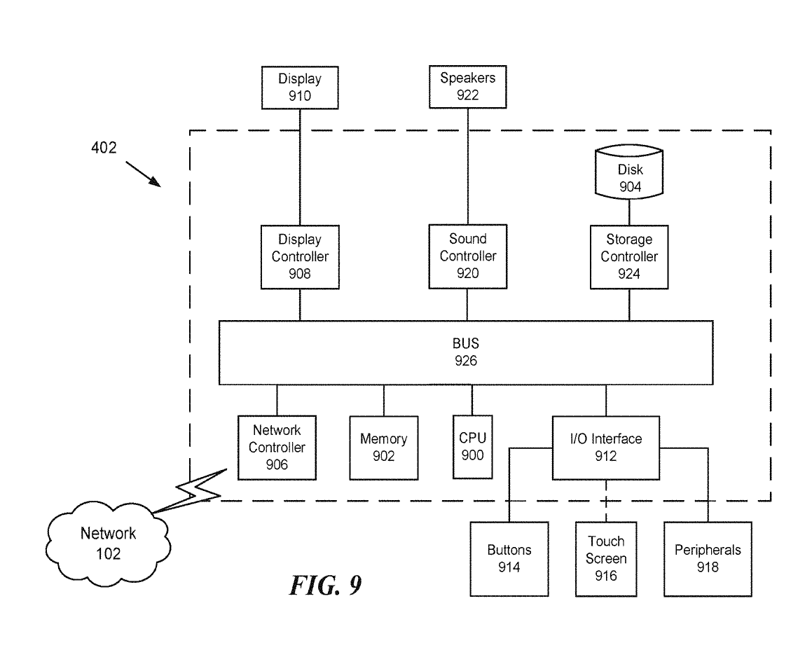

FIG. 4 is a schematic diagram of a system for certificate validation according to one example. The system may include a collector server 400 and one or more ISP proxy-cache servers. Each ISP proxy-cache server 402 is associated with the local ISP 104. The ISP proxy-cache server 402 represents one or more proxy servers associated with ISPs. The collector server 400 stores, in a database, revocation information that is received from one or more CAs 404. The one or more CAs 404 send digitally signed revocation information to the collector server 400. Then, the collector server 400 signs any received revocation information and sends the signed revocation information to the one or more ISP proxy-cache servers 402. In one aspect, each CA 404 sends the revocation information immediately in response to determining that a certificate has been revoked. Additionally or alternatively, the collection server 400 may poll each certificate authority 404 periodically to request revocation information. In addition, the collector server 400 may poll each certificate authority 404 to check a status of the CA 404. For example, the collector server 400 may determine whether an error may have occurred that may prevent the CA 404 from sending the revocation information to the collector server 400. In one aspect, upon determining that the status of the CA 404 indicates an error, the ISP proxy-cache server 402 may not accept digital certificates issued by the CA 404. The ISP proxy-cache server 402 may include a CPU 900 and a memory 902, as shown in FIG. 9.

The one or more ISP proxy-cache servers 402 store and cache the revocation information in a predefined structure. For example, the predefined structure may be a chained hash table data structure. Once a client 100 launches a secure connection, a certificate validation request may be sent and processed in the ISP proxy-cache server 402 associated with the local ISP 104 during the TLS handshake.

A digital certificate is an attestation that binds an entity to a public key. The digital certificate is signed and issued by the CA 404, which is responsible for the validity of the carried information in the digital certificate. The predominant digital certificate format is X.509 as described in S. Chokhani and W. Ford, “Internet x. 509 public key infrastructure certificate policy and certification practices framework,” 1999 incorporated herein by reference in its entirety. The digital certificate not only includes public key information, but also contains information about the key's cipher suite that is being used to sign the certificate, the certificate's serial number, the validity date, and other information. The serial number of a certificate is only unique within each CA, thus the serial number alone cannot be used as a certificate identity in the system described herein SecureGuard when certificates from multiple CAs are combined by the collector server 400. Therefore, the identity of a certificate may be defined as a combination of the certificate's serial number and the issuer of the CA identification such as the name of the CA.

In the system described herein, the CA 404 issues, revokes, and manages X.509 certificates for subscribed servers (e. g., web servers 106). The system described herein provides real-time services. The system implements a direct update. Each CA 404 updates the system “SecureGuard” once any of the signed certificates of CA 404 is revoked by sending the revoked certificate information to each collector server 400. Let nᵢ be the total number of revoked certificates at a time for C_{Ai}. The revoked certificates from CAᵢ can be represented as Revokedᵢ=(Certᵢ₁, Certᵢ₂, . . . , Certᵢₙᵢ), where each revoked certificate information can be summarized by Certᵢⱼ=(SNᵢⱼ;CAᵢ), where SNᵢⱼ is the serial number of the jth revoked certificate of CAᵢ. The revoked certificate information can be first hashed by CAᵢ to get ε=hash(Revokedᵢ), then digitally signed using the CA's secret key SK_{CAi} as denoted by:

Revᵢ=(Revokedᵢ,Sign_{SKCA}i(ε),T) (1)

Equation (1) contains the original revoked certificate information together with the signature of the hashed revocation information, and the timestamp T. Each CA 404 sends its signed revocation information Revᵢ to the collector server 400. HTTP protocol may be utilized for the communications between the CAs 404 and the collector server 400. Since the revocation information is already signed, the revocation information is protected against various attacks such as the impersonation attack as described in R. Fielding, J. Gettys, J. Mogul, H. Frystyk, L. Masinter, P. Leach, and T. Berners-Lee, “Hypertext transfer protocol,” RFC2616, 2006.

The collector server 400 is used as centralized revocation information port. The collector server 400 manages and collects revoked certificate information from multiple trusted CAs 404 as described previously herein. The collector server 400 reduces the number of transmissions that CAs 404 make to send revocation information to billions of clients. Thus, the bandwidth consumption is significantly reduced in the system described herein, compared to the known systems. In one aspect, the system may include a plurality of collector servers. For example, one or more collector servers may be associated with one or more ISP proxy cache servers.

The collector server 400 may send any received revocation information to the one or more ISP proxy-cache servers 402 associated after verifying Revᵢ in Equation (1) using the CA's public Key PK_{CAi}. The following procedure details the process for the collector server 400 to send received revocation information to the one or more ISP proxy cache servers 402. To protect the received certificates from multiple CAs 404, the collector server 400 applies the hash algorithm SHA-1 to the received revocation information from multiple CAs 404 as specified in Equation (2), where a is the number of revoked certificates received from the CAs:

δ=hash(Revoked₁,Revoked₂, . . . ,Revokedₐ) (2)

Using the RSA algorithm with a predetermined key size (e.g., 1024-bit), the collector server 400 signs the hashed information in Equation (2) using its secret key SK_{Collector}. The signature protects the transmitted revocation information from being forged or tampered with. Furthermore, a timestamp T may be included along with the digital signature to prove that the revoked information has not been altered by anyone after the stamped time. The transmitted information specified in Equation (3) is then sent over via network 102, for example, over an HTTP connection to the one or more ISP proxy-cache servers 402.

Rev=(Revoked₁,Revoked₂, . . . ,Revokedₐ,Sign_{SKCollector}(δ),T) (3)

The collector server 400 may employ the chained hash table data structure to store each revoked certificate information in certain structure. The revoked information includes: the serial number SNᵢⱼ and the CA issuer's name CAᵢ. A hash function SHA-1 (Secure Hash Algorithm) is used to index slots of serial number SNᵢⱼ that map into a linked list in which the CA issuer's name CAᵢ or an identification of the issuer certificate authority is found. Using the chained hash table reduces the time complexity of different operations that are performed on a large quantity of revoked certificate information. The average running time that takes to perform the inserting, deleting, and searching operations is O(1).

After verifying the collector signature and timestamp in equation (3), each ISP proxy-cache server 402 stores and caches the revocation information Certᵢⱼ obtained from each Revoked, in a chained hash table data structure. The one or more ISP proxy-cache servers 402 handle all clients' connections, including the secure connection where the TLS handshake is established. As a part of the TLS handshake, a validation certificate request is sent with a server hello message. The ISP proxy-cache server 402 fetches the server's certificate serial number and CA's issuer's name. Then, it verifies the requested certificate based on Algorithm 1.

Algorithm 1: ISP Proxy-Cache Server

Input: Connection ⊥ᵥ
if ⊥ᵥ HTTPS Request then

Connect;
Fetch Server's Cert_{if}
Get SN_{if} and CAᵢ
X ← (SN_{if};CAᵢ)
ISP Proxy-Cache Server searches for X on its cache
if X == True then

Send an error message
Terminate the connection ⊥ᵥ
else

Proceed ⊥ᵥ

end

end
else

Proceed ⊥ᵥ

end

end

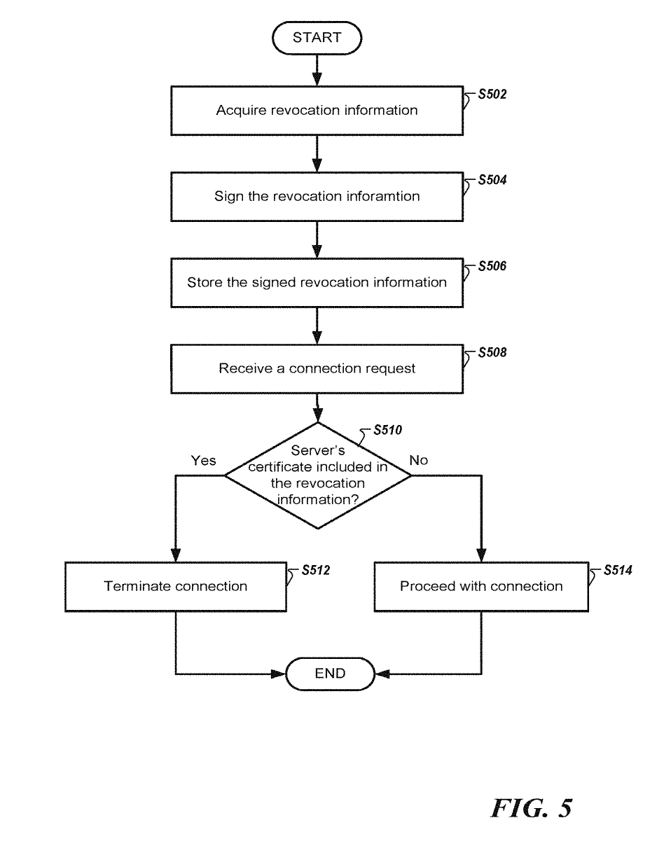

FIG. 5 is a flowchart that shows a method for certificate validation according to one example. At step S502, revocation information associated with one or more revoked certificates may be acquired by the collector server 400 from a plurality of certificate authorities. For example, once a certificate authority 404 determines that a certificate is not valid, the certificate information is uploaded to the collector server 400. The certificate information may include the certificate serial number, Subject Key Identifier, thumbprint of the certificate, and/or the certificate authority identification (e.g., name).

In one aspect, the revocation information may include the serial number of the revoked certificate. Once the revocation information is received by the collector server 400, the collector server 400 may associate the CA identification with the revocation information associated with the revoked certificate. The revocation information may also include the revocation date. The revocation date is the date when the certificate expired.

At step S504, the collector server 400 may sign the revocation information by applying a digital signature to the revocation information. In addition, the collector server 400 may apply a timestamp with the digital signature. Then, the collector server 400 may send the revocation information to one or more ISP proxy cache servers 402 associated with local ISPs (e.g., local ISP 104).

At step S506, the signed revocation information is stored. For example, the signed revocation information may be stored in a database or the memory 902 of the ISP proxy-cache server 402.

At step S508, a request of a connection may be received from a client 100. For example, the ISP proxy-cache server 402 may receive a request for connection from client 100 to a web server. Then, at step S510, the web server may respond to the ISP proxy-cache server 402 by providing certificate information of the server. In one aspect, the server's certificate information may include the minimum necessary information for identifying the server certificate. For example, the minimum necessary information may include an identifier of the certificate. In one aspect, the ISP proxy-cache server 402 may receive the entire certificate.

At step S510, after receiving the server certificate information, the CPU 900 may determine whether the certificate is identified in the stored revocation information. In response to determining that the certificate is included in the stored revocation information, the process moves to step S512. In response to determining that the stored revocation information is not included in the stored revocation information, the process moves to step S514.

At step S512, the connection is terminated. In addition, an alert may be generated and sent to the client 100. In one aspect, the client 100 may respond by sending to the ISP proxy cache server 402 an acknowledgment message acknowledging receipt of the alert message.

At step S514, if it is determined that the certificate is not identified in the stored revocation information, then communication between the client 100 and the web server is continued.

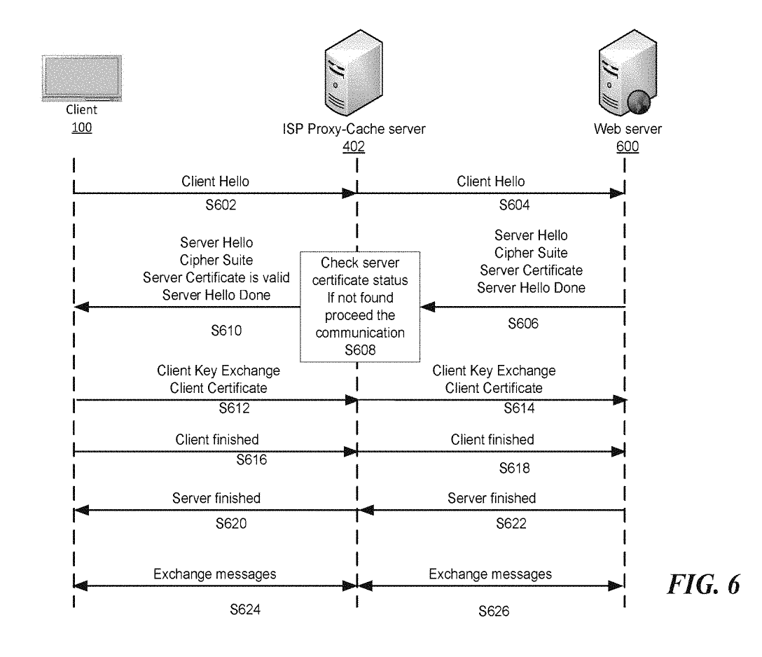

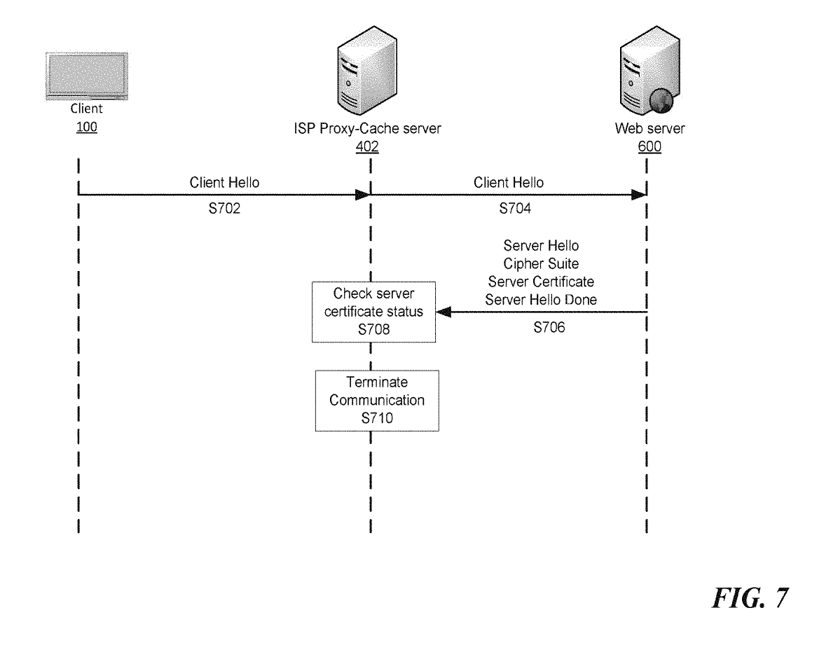

As described previously herein, if the server certificate's SNᵢⱼ along with CAᵢ are found in the ISP proxy-cache server cache, then the ISP proxy-cache server 402 terminates the handshake process as shown in FIG. 7, and may show a warning message indicating the certificate's status. Otherwise, the ISP proxy cache server 402 validates the requested certificate and forwards the valid certificate to the client to complete the handshake as shown in FIG. 6.

FIG. 6 is a flowchart that shows a process for establishing a connection between the client 100 and a web server 600 according to one example. The process may begin with a handshake between the client 100 and the web server 600. In the handshake, at step S602, the client 100 sends a “client hello” message (i.e., a connection request) to the ISP proxy-cache server 402. In turn, the ISP proxy cache server 402 sends the “client hello” message to the web server 600, at step S604. The web server 600 may respond with “a server hello” message that include a cipher suite, at step S606. The cipher suite is used to encrypt the subsequent messages. The web server 600 may also send “Server Hello Done” which may include a session ID. In addition, the web server 600 transmits a digital certificate information that binds an identity of the web server 600 (e.g., server name) to a public key of the web server 600. At step S608, the ISP Proxy-cache server 402 may check to see whether the digital certificate is valid. The ISP Proxy-cache server 402 may compare the digital certificate information with stored revocation information as described previously herein. In response to determining that the certificate is not found, the ISP Proxy-cache server 402 proceeds with the communication. At step S610, the ISP Proxy-cache server 402 sends the “server hello” message and an indication that the digital certificate of the web server 600 is valid to the client 100.

At step S612, the client 100 may send a key (e.g., a secret key encrypted with the public key of the web server 600) to the web server 600 through the ISP Proxy-cache server 402 (step S614) If the web server 600 requests client authentication, the client also sends the client's digital certificate, which binds an identity of the client (e.g., the client name) to a public key of the client. At step S616, the client 100 may send a “client finished” message to the web server 600 via the ISP proxy-cache server 402 (step 618) including a hash of the entire handshake to ensure that handshake messages have not been altered by a network attacker. The web server 600 may respond by sending a message “server finished” to the client 100 via the ISP proxy-cache server 402 indicating that the web server 600 has finished the authentication process (steps S620 and S622).

At step S624, the handshake concludes and is followed by messages transfer between the client 100 and the web server 600 via the ISP proxy-cache server 402 (step S626).

FIG. 7 is a flowchart that shows a process for establishing a connection between the client 100 and the web server 600 according to another example. The process may begin with a handshake between the client 100 and the web server 600. In the handshake, at step S702, the client 100 sends a “client hello” message (i.e., a connection request) to the ISP proxy-cache server 402. Upon receipt of the “client hello”, the ISP proxy cache server 402 sends the “client hello” message to the web server 600, at step S704. The web server 600 may respond with “a server hello” message that includes a cipher suite, at step S706. In addition, the web server 600 transmits a digital certificate information that binds an identity of the web server 600 (e.g., server name) to a public key of the web server 600. At step S708, the ISP Proxy-cache server 402 may check to see whether the digital certificate is valid. In response to determining that the certificate is not valid, the connection is terminated at step S710.

The system described herein, “SecureGuard” is applicable to all kinds of devices that deal with a certificate validation process to establish a secure communication. The system described herein completes the validation process at the ISP proxy-cache server side, thus the client 100 may be any device. The client 100 may include PCs, smartphones, dummy devices, or the like.

PCs: a user with a PC is able to verify the digital certificate while establishing a secure communication session. However, the system described herein supports a legacy client that has been inherited from software and hardware earlier than the current advanced technologies. For example, a user with the Windows Server 2003 operating system can check the digital certificate status using the validation system described herein. The user does not need to update any software or hardware to validate a certificate.

Smartphones: The limited availability of power and storage in smartphone devices is critical in terms of the certificate validation process. The system described herein processes the whole validation certificate at the ISP proxy-cache server's 402 side to save client resources. The system provides a cost effective solution to validate certificates when devices have limited resources.

Dummy Devices: The nature of most dummy devices with computational processing limitation has further requirements over the traditional PKI model. The computational processing limitations in dummy devices require that a cryptographic validation process uses less computational cost in the PKI model. In the system described herein, the load is outsourced from the dummy devices to the ISP proxy-cache servers 402. Dummy devices are no longer required to generate an OCSP request or download a CRL file. The system validates the digital certificate without demanding extra computation or resources from the dummy devices. Therefore, the system described herein “SecureGuard” fits well with various type of clients where efficiency must be achieved in the certificate validation process.

As described previously herein, the system includes the collector server 400. Provided herein are exemplary deployment scenarios of the collector server 400. It is important to note that the following options are illustrative and not exhaustive. Also, each option has trade-offs that impacts many aspects of the system design such as cost, risk, and update time. Cloud-Based Collector Cloud-based vendors like Dell and Cisco can handle this role and update the one or more ISP proxy-cache servers 402 with up to date revoked certificates. Well-known certificate authorities are limited. The cloud-based vendors can handle the service of collecting revoked certificates and update the one or more ISP proxy-cache servers 402 using cloud-based approaches which provide scalable and reliable solution as would be understood by one of ordinary skill in the art. Companies, such as Dell, may provide certificate validation along other currently provided security solution to ISPs using cloud-based technologies.

In one aspect, collector servers may be employed at the certificate authorities. Certificate authorities can implement a collector server that collects the revoked certificates from each CA. The advantage of this approach is to leverage the trust that certificate authorities have, and have a large number of the collector servers that is equal to the number of the certificate authorities.

The overhead communication cost is reduced in the system described herein compared with current certificate validation approaches, since the total number of collector servers is much less than the number of clients. In addition, each ISP proxy-cache server can subscribe with one or more collector servers 400 which keeps the ISP proxy-cache server updated even when one of the collector server is under attack.

To illustrate the capabilities of the validation system described herein, exemplary results are presented. The system described herein “SecureGuard” is evaluated and compared with other validation approaches based on a quantitative analysis in terms of computation time, bandwidth overhead, and storage size.

The details of the quantitative analysis of the system are identified by modeling the behavior of the certificate revocations. The analysis described herein, includes a quantitative evaluation of various costs incurred by the system described herein “SecureGuard” and other different certificate validation approaches. To model the certificate revocations over time, the behavior of the Probability Density Function (PDF) of the certificate revocations is identified. Assuming that at time X, α certificates are issued with an age of π days. On average αb % of the certificates are revoked within the time interval [X, X+π], where b is the percentage of the revoked certificates within the certificate lifetime π. At time X+π all issued certificates at time X are invalid (expired) regardless whether they have been revoked or not. Let R(t) be the ratio of the number of revoked certificates that happen between t and t+ΔY, where t is a time instant in [X, X+π], and the total number of the revoked certificates within [X, X+π]. Giving the distribution of revocation of issued certificates at time t:

R(t)=ke^{-kt} (4)

where k=0.26 which fits to the actual certificate revocations data very well. Let M represent the total number of valid certificates (non-revoked and non-expired). The certificates are issued on a constant rate

$$\frac{M . Δ X}{π T}$$

per issuance, where ΔY represents the time interval between two successive revocation certificates releases, and ΔX represents the time interval between two successive certificate generations.

$$Let θ = \frac{Δ Y}{T} and β = \frac{Δ X}{T} ,$$

thus β=θ when ΔY=ΔX. Then, the number of issued certificate per generation is:

$$α = \frac{M β}{π} = α β \qquad ( 5 )$$

Therefore, h(i), the total number of certificate revocations (non-expired) from the ith generation and before the current generation can be defined:

$$\begin{matrix}h ( i ) = α b {\int }_{0}^{i} R ( t ) \\ = α b {\int }_{0}^{i} {ke}^{- kt} dt = \frac{M β}{π} b ( 1 - {e}^{- kt} )\end{matrix} \qquad ( 6 )$$

Note that a steady-state condition (i.e., when a new certificate has been issued to replace an expired certificate) has been adopted to help us focus on the stable behavior of the revocation schemes and ignore other external factors. In one example, RevCerts, which is the total number of revoked certificates in a steady-state condition when ΔY=ΔX defined as:

$$\begin{matrix}Re vCerts = {\sum }_{i = 1}^{η} h ( β i ) = {\sum }_{i = 1}^{η} α b {\int }_{0}^{β i} R ( t ) dt \\ = \frac{M β}{π} b [ ( \frac{π}{β} - 1 ) - {e}^{k β} \frac{1 - {e}^{- k ( π - β )}}{1 - {e}^{- k β}} ]\end{matrix} \qquad ( 7 )$$

where

$$η = \frac{π}{β} - 1$$

is the number of certificate generations. But when ΔX≠ΔY, then the number of revoked certificates are released at time t′ΔY, when 1≦t′≦c, and c is a constant c>1 is:

$$\begin{matrix}Re vCerts ( {t}^{′} ) = {\sum }_{i = 1}^{\frac{π}{β}} h ( ( i - 1 ) β + {t}^{′} θ ) \\ = \frac{M β}{π} b [ ( \frac{π}{β} ) - {e}^{k θ j} \frac{1 - {e}^{- k π}}{1 - {e}^{- k β}} ]\end{matrix} \qquad ( 8 )$$

The maximum number of certificate revocations may occur when t′=c−1. Therefore, the average number of certificate revocations is:

$$\frac{ }{Re vCerts} = \frac{{\sum }_{{t}^{′} = 1}^{c} Re vCerts ( {t}^{′} )}{c} \qquad ( 9 )$$

Different certificate revocation approaches are evaluated including: CRL, OCSP, and SecureGuard under the same evaluation scenario. The notations and parameters values used in the analysis described herein are summarized in Table 2.

TABLE 2
The values of the parameters used in the quantitative evaluation

| Parameter | Description | Value | |
|---|---|---|---|
| M | Number of valid certificates | 500,000 | |
| π | Certificate lifetime | 365 | days |
| b | Percentage of revoked certificates | 15% | |
| | within the certificate lifetime | | |
| T | Number of second in a day | 86400 | Seconds |
| ΔX | Time interval between two | 1 | day |
| | certificate generations | | |
| ΔY | Time interval between two | 86400 | Seconds |
| | certificate revocation releases | | |

| | | |
|---|---|---|
| β | Constant factor | $\frac{ΔX}{T}$ |
| θ | Constant factor | $\frac{ΔY}{T}$ |
| U | Number of client | 50,000,000 |
| R_{v-daily} | Average number of daily requests | 50 |
| R_{v-issued} | Average number of daily requests issued to CA or CMAE | $min ( \frac{T}{ΔY} , {R}_{v - daily} )$ |
| R_{v-received} | Average number of daily requests received by CA, Proxy or CMAE | $U \cdot min ( \frac{T}{ΔY} , {R}_{v - daily} )$ |

To achieve a realistic evaluation, the certificate revocation approaches employs RSA with a key size of 1024-bit for a digital signature, and SHA-1 for a hashing algorithm. The benchmarks described in W. Dai, “Crypto++5.6.0 benchmarks,” 2009, K. Hansen, T. Larsen, and K. Olsen, “On the efficiency of fast RSA variants in modern mobile phones,” 2010, and J. Kong and X. Hong, “Anodr: anonymous on demand routing with untraceable routes for mobile ad-hoc networks,” in Proceedings of the 4th ACM international symposium on Mobile ad hoc networking & computing, ACM, 2003, pp. 291-302, each incorporated herein by reference in its entirety are used to define the overhead costs of cryptographic operations for both a desktop computer and a mobile device as shown in Table 3.

TABLE 3
Cryptographic operation costs
Cryptographic operations costs for Desktop Computer

| | | | |
|---|---|---|---|
| C_{Sign} | Time of a digital signature generation RSA | 1.48 | ms |
| | 1024-bit | | |
| C_{Hash} | Time of computing a hash algorithm SHA-1 | 0.0004 | ms |
| C_{Verify} | Time of a digital signature verification RSA | 0.07 | ms |
| | 1024-bit | | |

Cryptographic operations costs for Mobile Device

| | | | |
|---|---|---|---|
| C_{Sign} | Time of a digital signature generation RSA | 558 | ms |
| | 1024-bit | | |
| C_{Hash} | Time of computing a hash algorithm SHA-1 | 0.16 | ms |
| C_{Verify} | Time of a digital signature verification RSA | 29 | ms |
| | 1024-bit | | |

The evaluation includes a plurality of factors such as the computational time, required bandwidth, and storage size. The notations used herein to define the plurality of factors are described in R. H. Yap et al., “Quantifying the effects of more timely certificate revocation on lightweight mobile devices,” in Security Measurements and Metrics (Metrisec), 2011 Third International Workshop on, IEEE, 2011, pp. 31-40 incorporated herein by reference in its entirety. T_Cost_{A} is the computational time (in second) required by entity A, B_{wA-B} is the network bandwidth (in MB) used for a message transmission from entity A to entity B, and Size_{A} is the storage size (in MB) required on entity A.

To evaluate the performance of different revocation approaches, the following entities are introduced: CA representing the certificate authority, Client representing an entity, Proxy representing the ISP proxy-cache server, and Certificate Management Ancillary Entity (CMAE) representing a repository in CRL, Coil representing the collector server.

Using equation (9), the average number of revoked certificates is RevCerts. The length of revocation information field L_{Rev-Field}, in the system described herein, is 161 bytes for the CA's timestamp and signature as described in T. P. Hormann, K. Wrona, and S. Holtmanns, “Evaluation of certificate validation mechanisms,” Computer Communications, vol. 29, no. 3, pp. 291-305, 2006 incorporated herein by reference in its entirety. Additionally L_{SN} is the length of the certificate serial number=7 bytes, and L_{CA} is the length of CA issuer name=4 bytes Therefore, the revocation message size of the system described herein is: L_{Rev}=L_{Rev-Field}+└RevCerts┘(L_{SN}+L_{CA}).

The daily update costs are:

Bw_{CA-Coll}=R_{v-issued}·L_{Rev}

T_Cost_{CA}=R_{v-issued}·C_{Sign}

Bw_{coll}_{_}_{Proxy}=R_{v-issued}·L_{Rev}

T_Cost_{Coll}=R_{v-issued}·C_{Sign}

T_Cost_{Proxy}=R_{v-issued}·C_{Verify}

The daily request costs are:

Bw_{proxy-∀Client}=R_{v-issued}·(L_{SN}+L_{CA})

Bw_{proxy-∃Client}=R_{v-issued}·(L_{SN}+L_{CA})

The required storage are: Size_{Coll}=L_{Rev}, and Size_{Client}=0.

CRL: The average revocation certificates is └RevCerts┘. The length of CRL field L_{CRL}_{_}_{Fields} takes 400 bytes that includes both the length of the CRL header and signature, and the length of the CRL entry L_{CRL}_{_}_{Entry} is 39 bytes. Hence, the CRL file size is:

L_{CRL}=L_{CRL-Field}+└RevCerts┘(L_{CRL}_{_}_{entry}).

The daily update costs are:

Bw_{CA-CMAE}=R_{v-issued}L_{CRL}

T_Cost_{CA}=R_{v-issued}·C_{Sign}

T_Cost_{CMAE}=R_{v-issued}·C_{Verify}

The daily request costs are:

Bw_{CMAE-∀Client}=R_{v-received}·L_{CRL}

Bw_{CMAE-∃Client}=R_{v-issued}·L_{CRL}

T_Cost_{CA}=0

T_Cost_{CMAE}=0

T_Cost_{Client}=R_{v-issued}·C_{verify}

Finally, the required storage are: Size_{CA}=Size_{CMAE}=L_{CRL} and Size_{Client}=L_{CRL}.

OCSP: A nonce binds each OCSP response with its request. CA acts as an OCSP responder in the analysis described herein. There is no CAME involve in OCSP approach.

Therefore, there is no operation costs between CA and CAME. The length of OCSP response is L_{OCSP}=459 bytes. The daily request costs are:

Bw_{CA-∀Client}=R_{v-received}·L_{OCSP}

Bw_{CA-∃Client}=R_{v-issued}·L_{OCSP}

T_Cost_{CA}=R_{v-received}·C_{sign}

T_Cost_{Client}=R_{v-issued}·C_{Verify}

The required storage are: Size_{CA}=0, and Size_{Client}=0.

Table 4 shows the evaluation cost of different certificate validation systems.

| Entity | Cost (U = Update, R = Request) | Unit | SecureGuard | CRL | OCSP |
|---|---|---|---|---|---|
| CA | T_Cost_{CA}(U + R) | Seconds | 0.03 | 0.03 | 1.77 × 10⁹ |
| | T_Cost_{Cert}_{_{—}}_{Creation} | Seconds | 0.41 | 0.41 | 0.41 |
| | Size_{CA} | MB | — | 2.62 | — |
| | Bw_{CA-CMAE}(U) | MB | — | 62.88 | — |
| | Bw_{CA} − ∀Client(R) | MB | — | — | 5.50 × 10¹¹ |
| CMAE | T_Cost_{CMAE}(U + R) | Seconds | — | 0.00168 | — |
| | Size_{CMAE} | MB | — | 2.62 | — |
| | Bw_{CA-CMAE}(U) | MB | — | 62.88 | — |
| | Bw_{CMAE} − ∀Client(R) | MB | — | 3144 × 10⁶ | — |
| Coll | T_Cost_{Coll}(U + R) | Seconds | 0.00168 | — | — |
| | Size_{Coll} | MB | 0.14 | — | — |
| | BW_{CA-Coll}(U) | MB | 3.36 | — | — |
| | Bw_{Coll-Proxy}(U) | MB | 3.36 | — | — |
| | Bw_{Proxy-∀Client}(R) | MB | 18000 | — | — |
| Client | T_Cost_{Client}(R for Desktop Computer) | Seconds | 0.000001 | 0.00168 | 0.00168 |
| | T_Cost_{Client}(R for Mobile Device) | Seconds | 0.000001 | 0.70 | 0.70 |
| | Bw_{CA-∃Client}(R) | MB | — | — | 0.01 |
| | Bw_{CMAE-∃Client}(R) | MB | | 8.16 | — |
| | Bw_{Proxy-∃}(R) | MB | 0.00036 | — | — |
| | Size_{Client}(for Desktop Computer and Mobile Device) | MB | 0 | 2.62 | 0 |

It clearly can be seen that CRL imposed a high bandwidth between CAME and each client, also between CAME and CA. Additionally, the storage size at the client side increases with the growing size of CRLs. These cost is significant with limited resources devices. On the other hand, OCSP raises a high CA updating and querying processing cost. Also, the bandwidth between CA and all clients is significantly high. The system requires less computation time, bandwidth and storage size compared with CRL and OCSP.

In one example, the ISP proxy-cache server 402 is implemented on Python that runs under OS X 10 operating system on a machine with a 1.3 GHz Intel Core i5. OpenSSL is used to fetch X.509 certificate information including: the certificate's serial number and CA issuer's name during the TLS handshake. A serial number and CA issuer's name for the Alexa Top 1000 domains described in Alexa top 1 million domains,” are stored and cashed respectively in the collector server 400 and the ISP proxy-cache server 402. Clients are run on separate machines that generate requests where the TLS handshake is established. To measure the total time that takes to validate the server's certificate using the system described herein “SecureGuard” during the TLS handshake, two types of TLS handshakes are used: a full dummy TLS handshake that does not validate the server's certificate where the certificate is considered to be valid, and a full normal TLS handshake that validates the server's certificate using “SecureGuard” system. For each TLS handshake type, a single client is run that generates many requests one after the other. Then, the average time for each TLS handshake type is calculated. Similarly, the utilized processing resources for each TLS handshake type is measured. Two clients for each TLS handshake type were run and each client generates a request simultaneously. After 50 requests, the average usage of the processing resources is calculated for each type. Finally, the time that takes from the client to perform a full TLS handshake using different types of certificate validation approaches including: CRL, OCSP and SecureGuard system is calculated. Three clients on different machines with each have different certificate validation configuration are run. Then, the average time that takes from each client to establish a full TLS handshake using the aforementioned certificate validation approaches is measured.

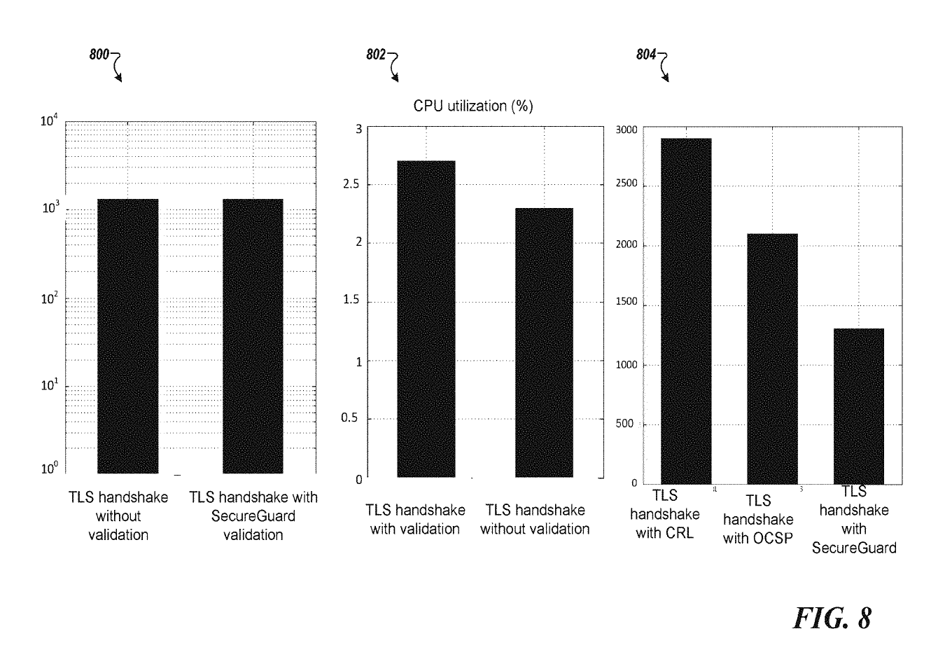

FIG. 8 is a schematic that shows a plurality of performance parameters of the system according to one example. Graph 800 and Graph 802 show the average time, and the percentage of the CPU utilization for each TLS handshake type. Notably, SecureGuard uses a very small amount of processing time and resource utilization to complete the validation process. The performance of the processes associated with the SecureGuard system adds less than 0.1 millisecond to the full TLS handshake for certificate validation process. Additionally, the impact of the validation system described herein on the CPU utilization of the ISP proxy-cache server is less than 0.4%.

Graph 804 illustrates how the validation methodology described herein affects the full TLS handshake time comparing with other approaches. A noticeable penalty for TLS handshake establishing time due to CRL is observed. Similarly, OCSP requires lesser time to validate the server's certificate than CRL, although it adds a significant latency time to the TLS handshake. Whereas the system described herein “SecureGuard” requires the least amount of time to complete the TLS handshake.

The system is operated securely, so that adversaries are less likely to launch any attack successfully. Additionally, a client may not accept an invalid certificate or reject a valid certificate under an attack scenario. Therefore, the system described herein provides a secure validation system that defeats several attacks. Replay and impersonation are the common attacks in most of the current validation systems, where attackers can manipulate revoked certificate information in several ways. For example, a replay attack in OCSP is able to substitute an OCSP response with an old response making the client out of date. To mitigate the hazard associated with these attacks, the system “SecureGuard” and associated methodology described herein utilizes an RSA digital signature along with a timestamp in each revoked certificate. The usage of the RSA digital signature is to authenticate the identity of the collector server, and the timestamp is to ensure the freshness of the received information.

The system described herein “SecureGuard is designed to provide an efficient validation process for digital certificates in secure communications. The system described herein is able to complete the validation process in a very short time without consuming the client resources. Once a validation request is sent as part of the TLS handshake, the whole validation process is completely handled at the ISP proxy-cache server's 402 side. Consequently, the system described herein “SecureGuard” not only preserves client resources such as bandwidth and storage overhead, but also eliminates the round trip expenses. This sets SecureGuard apart from OCSP, which requires a round trip time for the OCSP responder to obtain the certificate status, and increases client latency to complete the TLS handshake. Furthermore, each OCSP request is generated to validate only one certificate at a time which increase the load on the OCSP server. To use the system described herein, clients do not need to install any extra hardware or software. As a result, SecureGuard can validate certificates for any device including PCs, smartphones, and dummy devices. Whereas most of the validation systems require clients to install a software plug-in (as is the case of short-lived certificates), or to integrate extra hardware (as is the case of RevCast). Consequently, SecureGuard supports legacy software and hardware that exist in many systems. SecureGuard is an up-to-date system where all revoked certificates are being sent instantly from the CAs to the collector server 400. Immediate updating of the revocation information ensures the security of the validation process, and eliminates the risk that the client accepts a revoked certificate. CRL takes hours or even days to update clients with new revocation information. This delay makes clients vulnerable to many security flaws. Moreover, CRL totally relies on clients to download the updated CRL file.

The system and associated methodology described herein, according to one aspect, provides a new model to validate certificates in secure communications. The system described herein is a certificate validation system that resolves many limitations exhibited in current certificate validation systems. It utilizes existing infrastructure such as ISPs to provide certificate validation. Unlike other methods, the system described herein and associated methodology does not require extra hardware or software at the client side. SecureGuard does not incur any communication delay or additional computational cost.

The revocation system described herein is very practical, and can solve several issues existing in the current revocation methods. It can be a suitable option for devices with limited resources, such as smartphones, and dummy devices. In addition, the system may be based on a hyper method that combines two or more validation techniques.

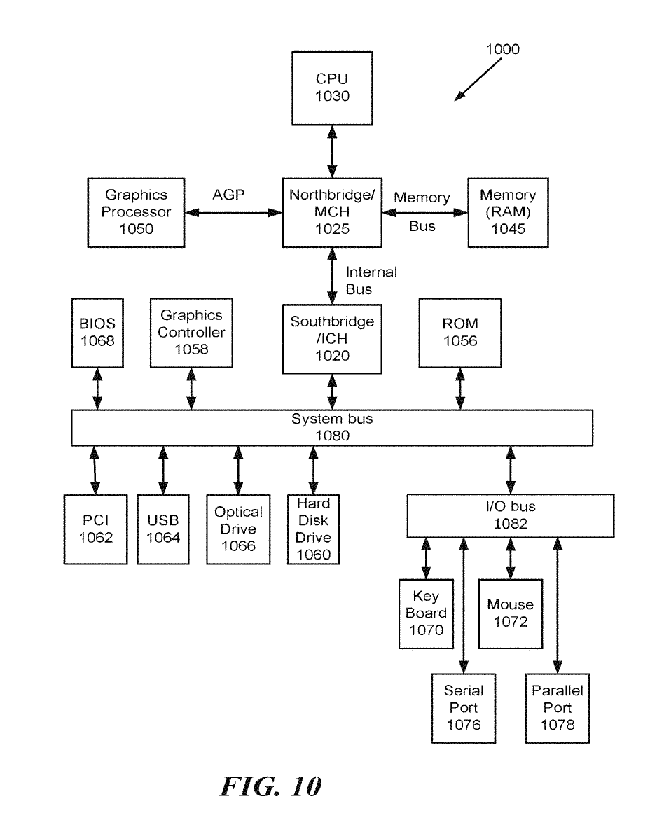

Next, a hardware description of the ISP proxy cache server 402 according to exemplary embodiments is described with reference to FIG. 9. The collector server 400, the CA 404, and the client 100 may be implemented by hardware identical to or similar to that described in FIGS. 9 and 10. In FIG. 9, the ISP proxy cache server 402 includes a CPU 900 which performs the processes described herein. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server communicates, such as a server or computer.

Further, the claimed advancements may be provided as a utility application, background daemon, or component of an operating system, or combination thereof, executing in conjunction with CPU 900 and an operating system such as Microsoft Windows 7, UNIX, Solaris, LINUX, Apple MAC-OS and other systems known to those skilled in the art.

In order to achieve the ISP proxy cache 402, the hardware elements may be realized by various circuitry elements, known to those skilled in the art. For example, CPU 900 may be a Xenon or Core processor from Intel of America or an Opteron processor from AMD of America, or may be other processor types that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The ISP proxy cache server in FIG. 9 also includes a network controller 906, such as an Intel Ethernet PRO network interface card from Intel Corporation of America, for interfacing with network 102. As can be appreciated, the network 102 can be a public network, such as the Internet, or a private network such as LAN or WAN network, or any combination thereof and can also include PSTN or ISDN sub-networks. The network 102 can also be wired, such as an Ethernet network, or can be wireless such as a cellular network including EDGE, 3G and 4G wireless cellular systems. The wireless network can also be WiFi, Bluetooth, or any other wireless form of communication that is known.

The ISP proxy cache server 402 further includes a display controller 908, such as a NVIDIA GeForce GTX or Quadro graphics adaptor from NVIDIA Corporation of America for interfacing with display 910, such as a Hewlett Packard HPL2445w LCD monitor A general purpose I/O interface 912 interfaces with a keyboard and/or mouse 914 as well as an optional touch screen panel 916 on or separate from display 910. General purpose I/O interface also connects to a variety of peripherals 918 including printers and scanners, such as an OfficeJet or DeskJet from Hewlett Packard.

A sound controller 920 is also provided in the ISP proxy cache server, such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the server. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

The exemplary circuit elements described in the context of the present disclosure may be replaced with other elements and structured differently than the examples provided herein.

FIG. 10 shows a schematic diagram of a data processing system, according to certain embodiments, for performing certificate validation utilizing the methodologies described herein. The data processing system is an example of a computer in which specific code or instructions implementing the processes of the illustrative embodiments may be located to create a particular machine for implementing the above-noted process.

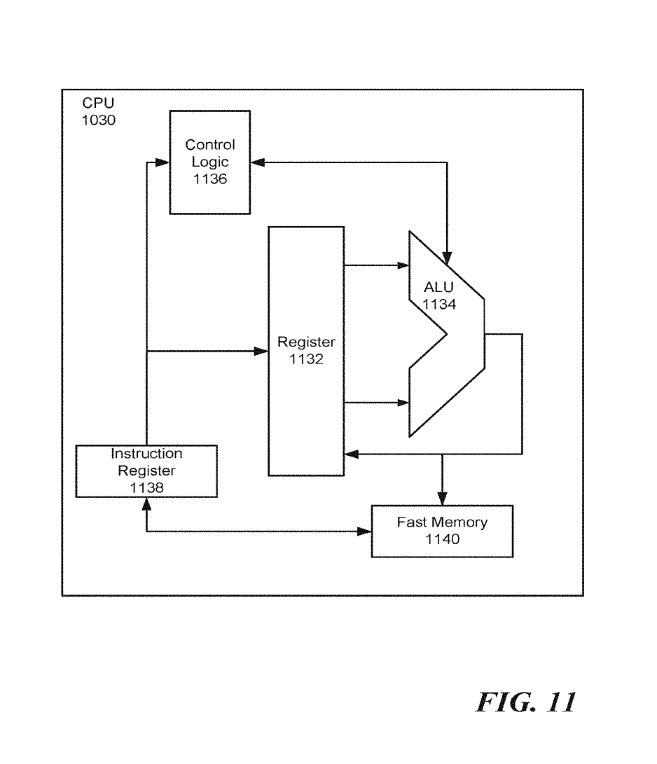

In FIG. 10, data processing system 1000 employs a hub architecture including a north bridge and memory controller hub (NB/MCH) 1025 and a south bridge and input/output (I/O) controller hub (SB/ICH) 1020. The central processing unit (CPU) 1030 is connected to NB/MCH 1025. The NB/MCH 1025 also connects to the memory 1045 via a memory bus, and connects to the graphics processor 1050 via an accelerated graphics port (AGP). The NB/MCH 1025 also connects to the SB/ICH 1020 via an internal bus (e.g., a unified media interface or a direct media interface). The CPU 1030 may contain one or more processors and may even be implemented using one or more heterogeneous processor systems. For example, FIG. 11 shows one implementation of CPU 1030.

Further, in the data processing system 1000 of FIG. 10, SB/ICH 1020 is coupled through a system bus 1080 to an I/O Bus 1082, a read only memory (ROM) 1056, an universal serial bus (USB) port 1064, a flash binary input/output system (BIOS) 1068, and a graphics controller 1058. In one implementation, the I/O bus can include a super I/O (SIO) device.

PCI/PCIe devices can also be coupled to SB/ICH 1020 through a PCI bus 1062. The PCI devices may include, for example, Ethernet adapters, add-in cards, and PC cards for notebook computers. Further, the hard disk drive (HDD) 1060 and optical drive 1066 can also be coupled to the SB/ICH 1020 through the system bus 1080. The Hard disk drive 1060 and the optical drive or CD-ROM 1066 can use, for example, an integrated drive electronics (IDE) or serial advanced technology attachment (SATA) interface.

In one implementation, a keyboard 1070, a mouse 1072, a serial port 1076, and a parallel port 1078 can be connected to the system bus 1080 through the I/O bus 1082. Other peripherals and devices that can be connected to the SB/ICH 1020 include a mass storage controller such as SATA or PATA (Parallel Advanced Technology Attachment), an Ethernet port, an ISA bus, a LPC bridge, SMBus, a DMA controller, and an Audio Codec (not shown).

In one implementation of CPU 1030, the instruction register 1138 retrieves instructions from the fast memory 1140. At least part of these instructions are fetched from the instruction register 1138 by the control logic 1136 and interpreted according to the instruction set architecture of the CPU 1030. Part of the instructions can also be directed to the register 1132. In one implementation, the instructions are decoded according to a hardwired method, and in another implementation, the instructions are decoded according a microprogram that translates instructions into sets of CPU configuration signals that are applied sequentially over multiple clock pulses. After fetching and decoding the instructions, the instructions are executed using the arithmetic logic unit (ALU) 1134 that loads values from the register 1132 and performs logical and mathematical operations on the loaded values according to the instructions. The results from these operations can be feedback into the register and/or stored in the fast memory 1140. According to certain implementations, the instruction set architecture of the CPU 1030 can use a reduced instruction set architecture, a complex instruction set architecture, a vector processor architecture, a very large instruction word architecture. Furthermore, the CPU 1030 can be based on the Von Neuman model or the Harvard model. The CPU 1030 can be a digital signal processor, an FPGA, an ASIC, a PLA, a PLD, or a CPLD. Further, the CPU 1030 can be an x86 processor by Intel or by AMD; an ARM processor, a Power architecture processor by, e.g., IBM; a SPARC architecture processor by Sun Microsystems or by Oracle; or other known CPU architecture.

The present disclosure is not limited to the specific circuit elements described herein, nor is the present disclosure limited to the specific sizing and classification of these elements.

The functions and features described herein may also be executed by various distributed components of a system. For example, one or more processors may execute these system functions, wherein the processors are distributed across multiple components communicating in a network. The distributed components may include one or more client and server machines, which may share processing in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

The hardware description above, exemplified by any one of the structure examples shown in FIG. 9 or 10, constitutes or includes specialized corresponding structure that is programmed or configured to perform the algorithm shown in FIG. 5.

Obviously, numerous modifications and variations are possible in light of the above teachings. It is therefore to be understood that within the scope of the appended claims, the invention may be practiced otherwise than as specifically described herein.

The system “SecureGuard” and associated methodology described herein provides a certificate validation method. The system described herein “SecureGuard” requires less computation time, network bandwidth, and storage size compared with current validation systems. Additionally, SecureGuard can validate the certificate for any device, because the cryptographic and validation operations occur at the ISP proxy-cache server side. The system is push-based. Therefore, “SecureGuard” preserves the client side system resources. Further, the systems and methods described herein provide an improvement to secure communications between a client and a web server by providing the ability to validate a certificate using up to date revocation information.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

The above disclosure also encompasses the embodiments listed below.

(1) A method for certificate validation, the method including: acquiring, via a collector server with processing circuitry, revocation information associated with one or more revoked certificates from a plurality of certificate authorities; signing, via the processing circuitry, the revocation information; sending, via the processing circuitry, the revocation information to at least one proxy server; storing, in memory associated with a proxy server, the signed revocation information; receiving, at the proxy server, a request from a client device to connect to a web server; receiving, at the proxy server, certificate information associated with a certificate of the web server in response to receiving the request; comparing, via processing circuitry associated with the proxy server, the certificate information with stored revocation information; and terminating, via the processing circuitry associated with the proxy server, a connection between the web server and the client device when the certificate information matches a revoked certificate information included in the stored revocation information.

(2) The method of feature (1), further including applying, at the collector server, a hashing algorithm to the revocation information; and storing, in memory associated with the collector server, the hashed revocation information in a chained hash table data structure, the chained hash table data structure having index slots of unique identification numbers that map into a linked list having an identification of the certificate authority associated with the unique identification numbers.

(3) The method of feature (2), in which the step of signing includes applying a RSA algorithm to the hashed revocation information using a secret key associated with the collector server; and applying a timestamp.

(4) The method of feature (3), further including verifying, at the proxy server, a signature of the revocation information by validating the secret key associated with the collector server.

(5) The method of any of features (3) or (4), further including sending, via a certificate authority, revocation information to the collector server, the revocation information including revoked certificate information, a signature of hashed revocation information and the timestamp; and verifying, by the collector server, the revocation information received from the certificate authority using a public key associated with the certificate authority.

(6) The method of any of features (1) to (5), in which the revocation information includes a unique identification number and a certificate authority identifier associated with each of the one or more revoked certificates.

(7) The method of any of features (1) to (6), further including outputting, by the proxy server, a warning message indicating that the certificate information is associated with a revoked certificate when the certificate information matches revoked certificate information included in the stored revocation information.

(8) The method of any of features (1) to (7), in which the signed revocation information is stored in a chained hash table data structure.

(9) A system for certificate validation, the system including a collector server configured to receive revocation information associated with one or more revoked certificates from a plurality of certificate authorities, sign the revocation information, and send the signed revocation information to at least one proxy server; and a proxy server configured to receive the signed revocation information from the collector server, store the signed revocation information, receive a request from a client device to connect to a web server, receive certificate information associated with a certificate of the web server in response to receiving the request, compare the certificate information with stored revocation information, and terminate a connection between the web server and the client device when the certificate information matches revoked certificate information included in the stored revocation information.

(10) The system of feature (9), in which the collector server is further configured to: apply a hashing algorithm to the revocation information, and store the hashed revocation information in a chained hash table data structure, the chained hash table data structure having index slots of unique identification numbers that map into a linked list having an identification of the certificate authority associated with the unique identification numbers.

(11) The system of feature (10), in which the collector server is further configured to apply a RSA algorithm to the hashed revocation information using a secret key associated with the collector server, and apply a timestamp.

(12) The system of feature (11), in which the proxy server is further configured to verify a signature of the signed revocation information by validating the secret key associated with the collector server.

(13) The system of feature (11), in which the collector server is further configured to verify a signature of the revocation information based on a public key associated with a certificate authority.

(14) The system of any of features (9) to (13), in which the revocation information includes a unique identification number and a certificate authority identifier associated with each of the one or more revoked certificates.

(15) The system of any of features (9) to (14), in which the proxy server is further configured to output a warning message indicating that the certificate information is associated with a revoked certificate when the certificate information matches revoked certificate information included in the stored revocation information.

(16) The system of any of features (9) to (15), in which the proxy server is further configured to store the revocation information in a chained hash table data structure.

(17) A non-transitory computer readable medium storing computer-readable instructions therein which when executed by a computer cause the computer to perform a method of any one of features (1) to (8).

1. A method for certificate validation, the method comprising:
acquiring, via a collector server with processing circuitry, revocation information associated with one or more revoked certificates from a plurality of certificate authorities;
signing, via the processing circuitry, the revocation information;
sending, via the processing circuitry, the signed revocation information to at least one proxy server;
storing, in memory associated with a proxy server, the signed revocation information;
receiving, at the proxy server, a request from a client device to connect to a web server;
receiving, at the proxy server, certificate information associated with a certificate of the web server in response to receiving the request;
comparing, via processing circuitry associated with the proxy server, the certificate information with stored revocation information; and
terminating, via the processing circuitry associated with the proxy server, a connection between the web server and the client device when the certificate information matches revoked certificate information included in the stored revocation information.

2. The method of claim 1, further comprising:
applying, at the collector server, a hashing algorithm to the revocation information; and
storing, in memory associated with the collector server, the hashed revocation information in a chained hash table data structure, the chained hash table data structure having index slots of unique identification numbers that map into a linked list having an identification of the certificate authority associated with the unique identification numbers.

3. The method of claim 2, wherein the step of signing includes:
applying a RSA algorithm to the hashed revocation information using a secret key associated with the collector server; and
applying a timestamp.

4. The method of claim 3, further comprising:
verifying, at the proxy server, a signature of the revocation information by validating the secret key associated with the collector server.

5. The method of claim 3, further comprising:
sending, via a certificate authority, revocation information to the collector server, the revocation information including revoked certificate information, a signature of hashed revocation information and the timestamp; and
verifying, by the collector server, the revocation information received from the certificate authority using a public key associated with the certificate authority.

6. The method of claim 1, wherein the revocation information includes a unique identification number and a certificate authority identifier associated with each of the one or more revoked certificates.

7. The method of claim 1, further comprising:
outputting, by the proxy server, a warning message indicating that the certificate information is associated with a revoked certificate when the certificate information matches revoked certificate information included in the stored revocation information.

8. The method of claim 1, wherein the signed revocation information is stored in a chained hash table data structure.

9. A system for certificate validation, the system comprising:
a collector server configured to
receive revocation information associated with one or more revoked certificates from a plurality of certificate authorities,
sign the revocation information, and
send the signed revocation information to at least one proxy server; and
a proxy server configured to
receive the signed revocation information from the collector server,
store the signed revocation information,
receive a request from a client device to connect to a web server,
receive certificate information associated with a certificate of the web server in response to receiving the request,
compare the certificate information with stored revocation information, and
terminate a connection between the web server and the client device when the certificate information matches revoked certificate information included in the stored revocation information.

10. The system of claim 9, wherein the collector server is further configured to:
apply a hashing algorithm to the revocation information, and
store the hashed revocation information in a chained hash table data structure, the chained hash table data structure having index slots of unique identification numbers that map into a linked list having an identification of the certificate authority associated with the unique identification numbers.

11. The system of claim 10, wherein the collector server is further configured to:
apply a RSA algorithm to the hashed revocation information using a secret key associated with the collector server, and
apply a timestamp.

12. The system of claim 11, wherein the proxy server is further configured to:
verify a signature of the signed revocation information by validating the secret key associated with the collector server.

13. The system of claim 11, wherein the collector server is further configured to:
verify a signature of the revocation information based on a public key associated with a certificate authority.

14. The system of claim 9, wherein the revocation information includes a unique identification number and a certificate authority identifier associated with each of the one or more revoked certificates.

15. The system of claim 9, wherein the proxy server is further configured to:
output a warning message indicating that the certificate information is associated with a revoked certificate when the certificate information matches revoked certificate information included in the stored revocation information.

16. The system of claim 9, wherein the proxy server is further configured to:
store the revocation information in a chained hash table data structure.

17. A non-transitory computer readable medium storing computer-readable instructions therein which when executed by a computer cause the computer to perform a method for certificate validation, the method comprising:
acquiring revocation information associated with one or more revoked certificates from a plurality of certificate authorities;
signing the revocation information;
sending the signed revocation information to at least one proxy server;
storing the signed revocation information;
receiving a request from a client device to connect to a web server;
receiving certificate information associated with the web server in response to the request;
comparing the certificate information with the stored revocation information; and
terminating a connection between the client device and the web server when the certificate information matches revoked certificate information included in the stored revocation information.
